(19) United States
(12) Patent Application Publication
(10) Pub. No.: US 2004/0016587 A1
(43) Pub. Date: Jan. 29, 2004

(54) Vehicle security method and device

(76) Inventors: John Edwin James Jones, Oxon (GB); Deborah Jane Jones, Oxon (GB)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/415,379

(22) PCT Filed: Oct. 24, 2001
(86) PCT No.: PCT/GB01/04706

(30) Foreign Application Priority Data
Oct. 27, 2000 (GB) 0026309.5

(51) Int. Cl. B60R 25/00

(52) U.S. Cl. 180/287

(57) ABSTRACT

A method of providing security for an interior region of a vehicle (12) having an opening bounded by frame through which opening access can be had to the interior region from outside the vehicle, the frame being provided with a closure mechanism such as a door, the closure mechanism being displaceable relative to the frame between a closed position, when the opening is closed by way of the closure member (13) and an open position wherein the closure member allows access through the opening to the interior region; the closure member containing a window (19) characterized by the steps of locating from within the interior region over the window in the closure member a blocking device; the blocking device being adapted, in a working position, for demountable coupling of the blocking device to the closure member; providing on the blocking device a displaceable extension (25′, 26′) such that, with the closure mechanism in the closed position and the blocking mechanism in its working position, the extension (25′, 26′, B, B′) can be moved between a locking position wherein the extension interacts with the frame or an extension thereof so as to resist movement of the closure member from the closed position towards the open position; and a release position wherein the extension no longer interacts with the frame or an extension thereof so as to enable the closure member to move from the closed position towards the open position.

### TECHNICAL FIELD

This invention relates to a vehicle secuity method and device. It is particularly concerned with the security of a road vehicle. However the method is applicable to vehicles other than road vehicles as will become apparent.

### BACKGROUND ART

The security of a vehicle can be achieved in a number of ways. For example one can isolate the vehicle (such as by location in a garage) from an approach by any except one approved by the person responsible for the vehicle. In another example the vehicle can be equipped with some signal gererating means which triggered by an intruder. In this latter case the generating means can be a local alarm (for example one involving sound and/or light signals) or a remote alarm by way of a wireless signal or a combination of both near and remote generating means.

The above examples will not necessarily achieve the desired end of security in practice. A vehicle is intended for transportation, typically of people, goods or both. Isolation in a garage may be feasible at the start or end of a run for a vehicle. However effective isolation may not readily be achieved while the vehicle is in transit from one location to another. Typically: suitable accommodation may not be available on a selected route; a route having been selected may subsequently have to be changed; the vehicle may be subject to delay from matters such as driver incapacity, accident, vehicle damage, fuel shortage, transit authorisation or industrial action.

For a vehicle equipped with a signal generating means security is dependent on an adequate response being generated once the means has been triggered. Typically in the case of a locally generated alarm it is not always the case that local resident or bystanders will necessarily respond favourably, if indeed at all, by contacting an appropriate authority.

Security in the case of a given vehicle can involve, for example, protection of one or more of the following.

1 Use of the vehicle as such (that is to say as driveable transport). This can involve making, or at least creating the impression, that access to the vehicle will be difficult, time consuming, or attract attention, or even if access is achieved it may not be possible to readily operate the vehicle.

2 An article attached to the vehicle enabling it to, or contribution towards its, function (such as a wheel, light, tool, number plate or document). Given that such articles must necesarily be accessible from outside the vehicle then they can be attached by means resisting their unauthorised removal.

3 An item contained within the vehicle (such as radio, luggage, and documents). Apart from making access to the interior of the vehicle diffcult (as outlined in Item 1 above) security benefits from concealing the item from the view of a person looking into the vehicle.

4 Goods being transported typically by a commercial goods vehicles. A goods carrying region of the vehicle is frequently self contained and isolated from the cab where the driver of the vehicle is located. Such a goods carrying region does not require windows or apertures which are required by a driver in his cab so as to be able operate the vehicle. In such cases the goods carrying region of the vehicle can be accessed by way of a door or doors equipped with extensive locking means.

### DISCLOSURE OF INVENTION

According to a first aspect of the present invention there is provided a method of providing security for an interior region of the vehicle having an opening bounded by a frame through which opening access can be had to the interior region from outside the vehicle, the frame begin provided with a closure means such as a door, the closure means being displaceable relative to the frame between a closed position, when the opening is closed by way of the closure member and an open postion wherein the closure member allows access through the opening to the interior region; the closure member containing a window characterised by the steps of:

1 locating from within the interior region over the window in the closure member a blocking device; the blocking device be adapted, in a working position, for demountable coupling of the blocking device to the closure member;

2 providing on the blocking device a displaceable extension such that, with the closure means in the closed position and the blocking means in its working position, the extension can be moved between:

a locking position wherein the extension interacts with the frame or an extension thereof so as to resist movement of the closure member from the closed position towards the open position; and

a release position wherein the extersion no longer interacts with the frame or an extension thereof so as to enable the closure member to move from the closed position towards the open position.

According to a first preferred version of the first aspect of the present invention the window contains at least one glass panel and the locating step includes positioning the blocking device between the interior region and the glass panel.

According to a second preferred version of the first aspect of the present invention or of the first preferred version thereof the blocking device includes display means for information, such as a security warning, and the locating step serves to cause such a sign, such as a security warning, to be displayed outwardly through the window.

According to third preferred version of the first aspect of the present invention or of any preceding preferred version thereof wherein the step of providing locking means on the extention whereby the extension can be maintained in the locking position by a user located in the interior region.

According to a second aspect of the present invention there is provided a security unit for mounting on a door so as to extend across a window located in the door the unit comprising a blocking device having at least two spaced apart fixing locations whereby the device can be mounted across a surround for the window defined by the door and at least one extension means mounted on the blocking device by means enabling the extension means in a first, retracted, position to lie within a boundary defined by a peripheral region of the door and in a second, extended, position to extend beyond the peripheral region of the door to interact with a region bounding the door so as to limit motion of the door away from a closed portion; the extension mean being capable of being secured, at least when in its extended position, relative to the remainder of the blocking device by a lock.

According to a first preferred version of the second aspect of the present invention the extension means are attached to the blocking device by a hinge allowing the extention means to pivot relative to the remainder of the blocking device.

According to a second preferred version of the second aspect of the present invention the extenion means are attached to the blocking device by means allowing the extension means to slide relative to the remainder of the blocking device.

According to a third preferred version of the second aspect of the present invention or of any preceding preferred versions thereof the device includes a lock for securing the extension means in its extended position relative to the remainder of the blocking device.

According to a third aspect of the present invention there is provided a road vehicle equipped with a device according to the second aspect or any preferred version thereof.

A particular concern of the present invention is to provide protection on a static vehicle for a driver or other occupant of the vehicle and for the contents of the cab of the vehicle from burglary or attack by making it extremely difficult to obtain access to the interior of the vehicle either by breaking a window or opening a door of the vehicle. Broadly this is achieved by providing a blocking means for the window which further serves to prevent opening of the door independently of any conventional locking means for the door.

### BRIEF DESCRIPTION OF DRAWINGS

An exemplary embodiment of the invention will now be described with reference to the accompanying drawings of a security device for a commercial vehicle of which:

FIG. 1 is a side view of the front section of the vehicle;

FIG. 2 shows a part sectioned front view from above of the vehicle cab;

FIG. 3 shows a interior view of the vehicle cab;

FIG. 4 shows an assembled and an exploded view of a security device;

FIG. 5 shows a part of a component of FIG. 4 in greater detail;

FIG. 6 shows an alternative component;

FIG. 7 shows a part of a component of FIG. 4 in greater detail.

The drawings variously show

### MODE FOR CARRYING OUT THE INVENTION

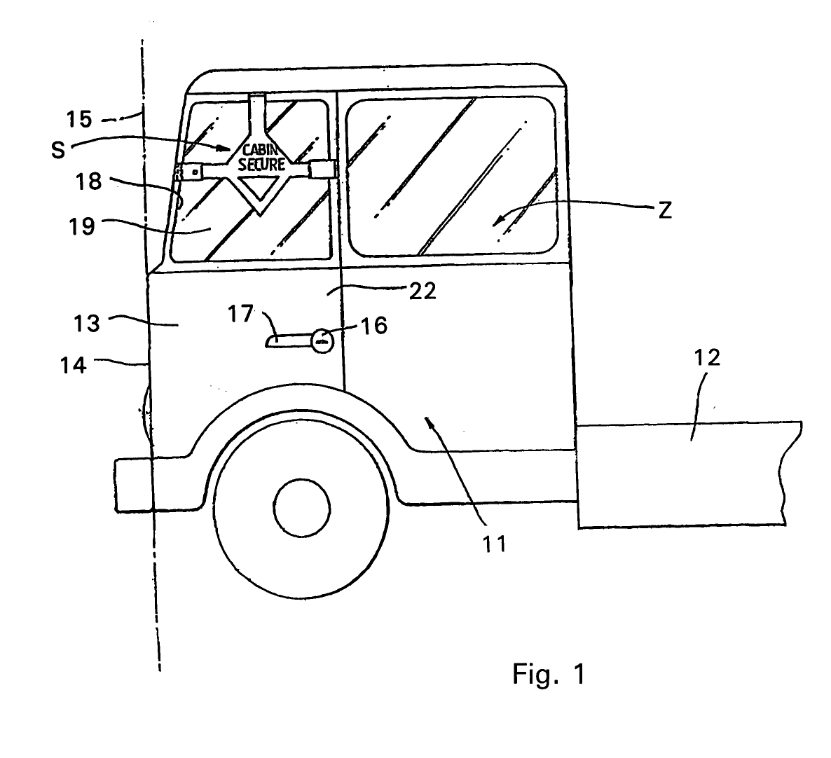

FIG. 1 show sleeper cab 11 of a commercial goods carrying vehicle 12 having a conventional door 13 having hinges mounted towards leading edge 14 of the door to enable the door 13 to pivot in a conventional manner about axis 15. Trailing end 16 of the door 13 when in its closed position as shown in FIG. 1, is capable of being conventionally locked in place by lock 16 with associated handle 17. The door 13 contains an aperture 18 in which window 19 is located for movement between an open and a closed position. The aperture 18 is shown obscured by a security device S which will be described hereafter more detail.

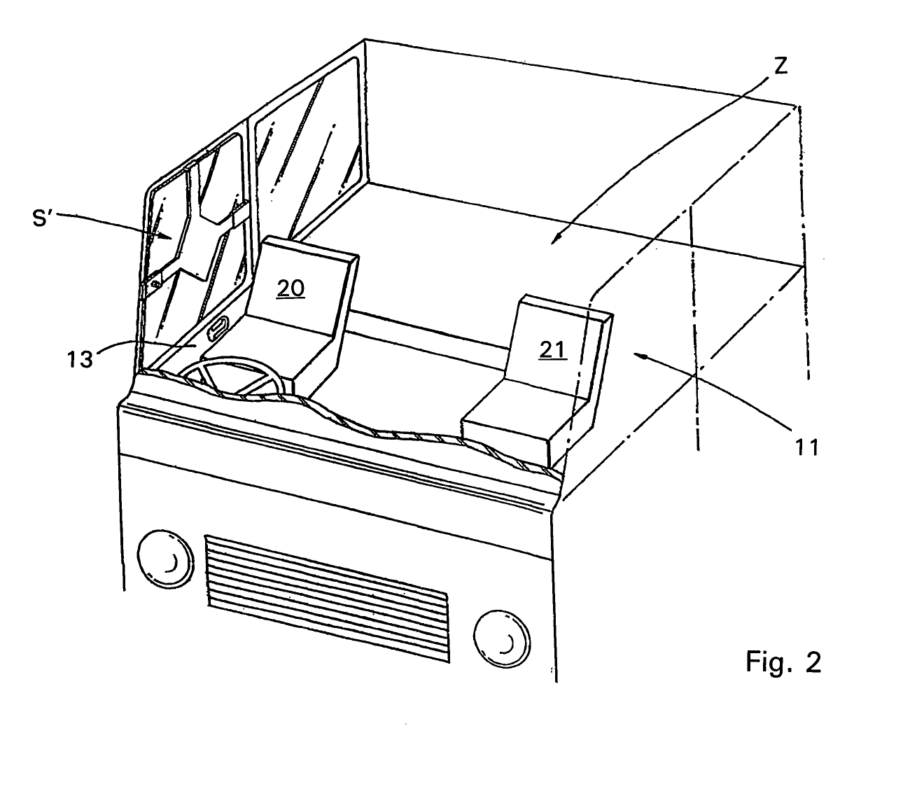

FIG. 2 show the interior of sleeper cab 11 with seats 20, 21. Inner side of door 21 next to the driving seat 20 is shown also equipped with a security device S′.

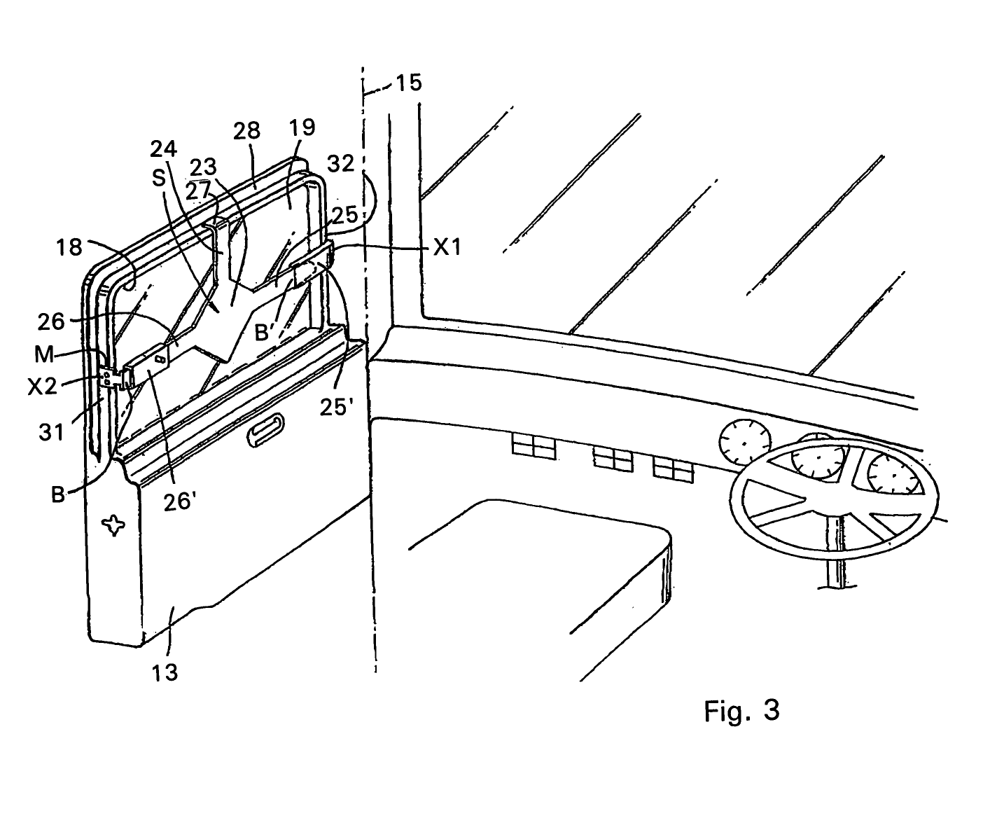

FIG. 3 shows door 13 in an open position with security device S mounted behind window 19 in aperture 20. As mentioned in connection with FIG. 1 the door 13 is mounted by hinges to pivot about axis 15. The device S comprise a cruciform member 23 with vertical arm 24, first horizontal arm 25 and second horizontal arm 26.

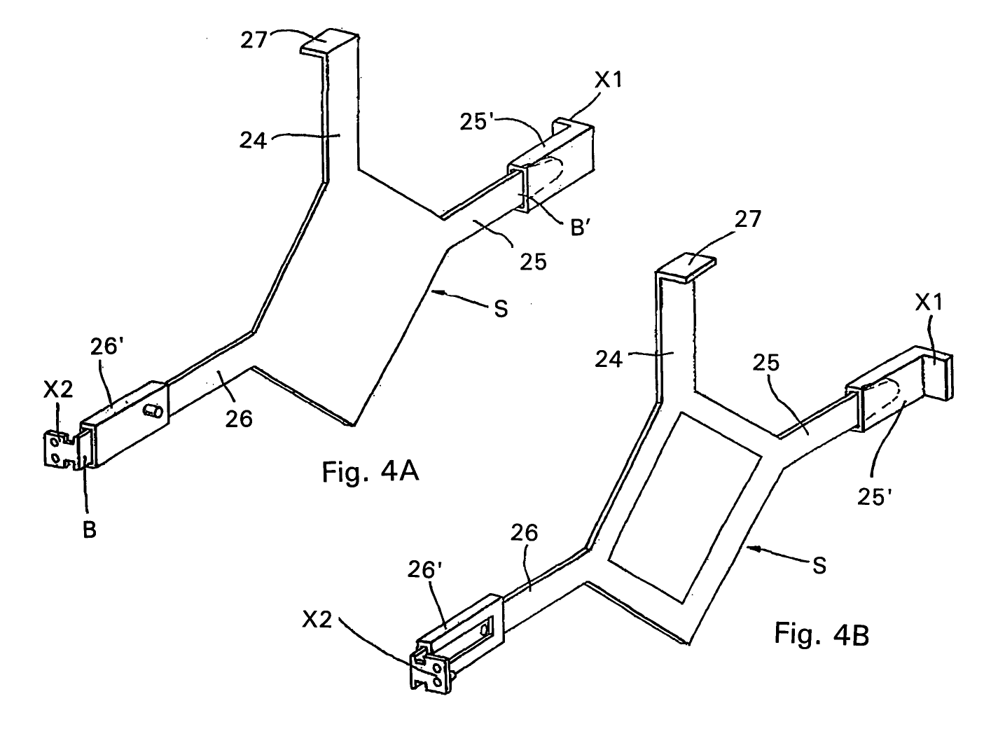

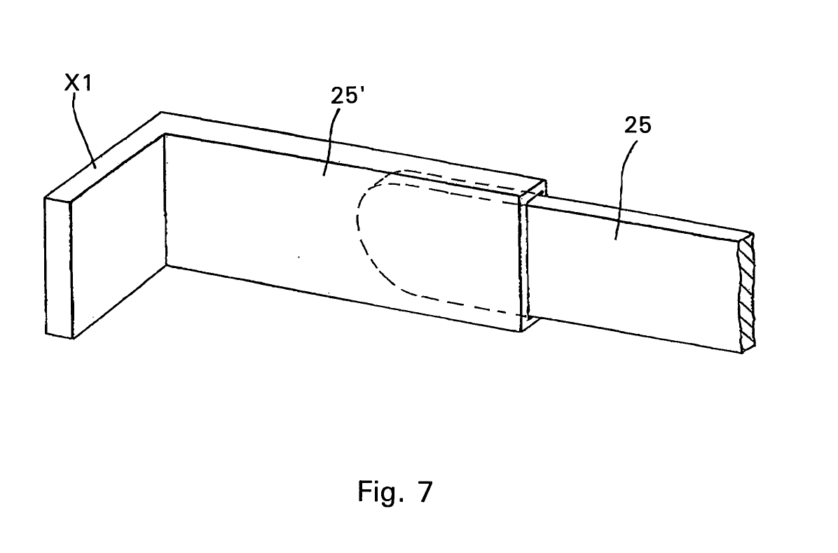

The security device S and a modified version of it will now be briefly described with reference to FIGS. 3 and 4 to 7.

The vertical arm 24 is located (FIG. 3) by hooked end 27 over top window frame member 28 so that, with door 13 shut the end 27 is trapped in place. The horizontal arms 25, 26 are equipped at their ends with, respectively, slidable sleeves, 25′, 26′ with hooked ends, respectively X1, X2. Each sleeve 25′, 26′ can be drawn in or out relative to the cruciform member 23 to provide for the device S to be snugly fitted an clamped around the side members 31, 32 framing the aperture 18. By providing slidable sleeves 25′, 26′ on the horizontal members 25, 26 the device S can be adapted for a wide range of window and door arrangements. Thus devices according to the invention can be readily adapted for mounting on ranges of vehicles of more than one manufacturer. In addition each sleeve 25′, 26′ contains an extendible bar B, B′. The appropriate bar B, B′ is extended from whichever of the sleeves 25, 26 occupies the side of the door 13 remote from the axis 15. It is that side of the door which move outwardly when the door is opened. By providing for the extension of the bar B, B′ when the device S is in place the bar contacts region M of the door frame and resists any attempt to draw the door open regardless of the state of engagement of lock 16.

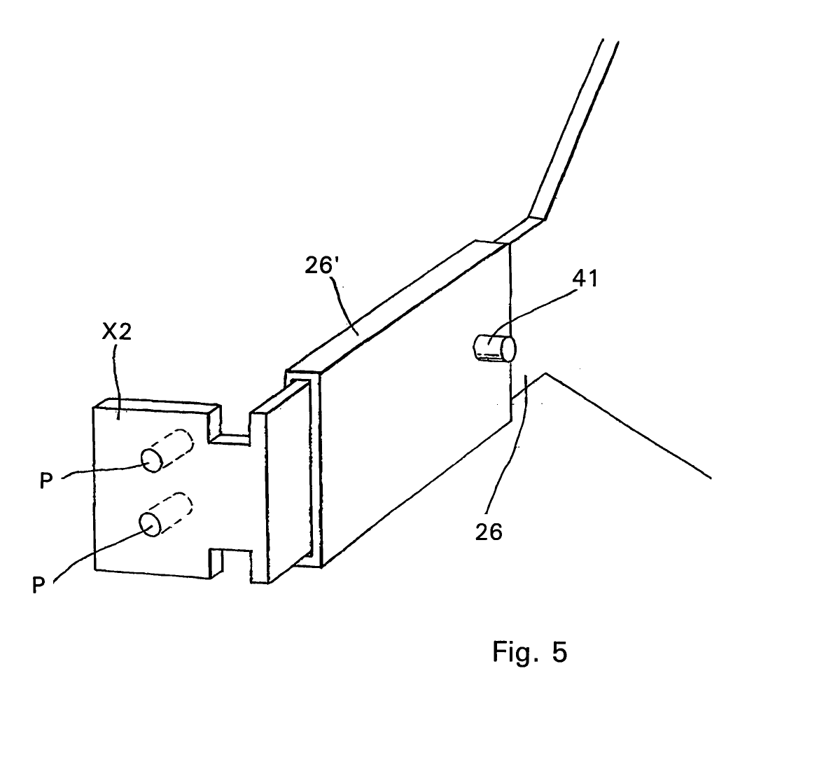

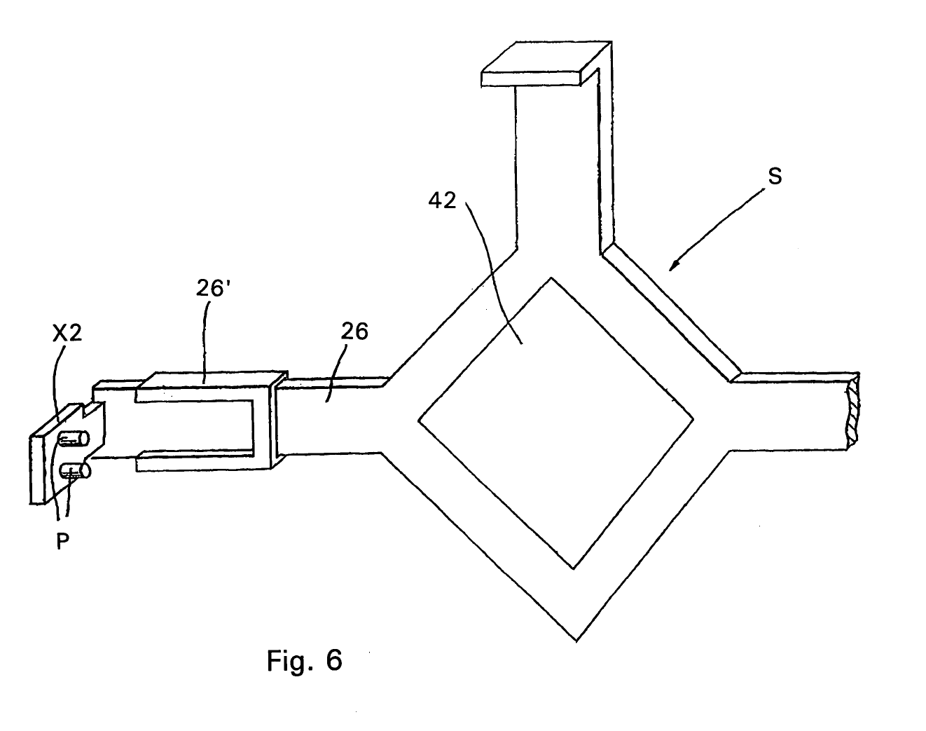

FIGS. 5 and 6 shows sleeve 26′ in more detail with hooked end X2 equipped with two dowel pins P so that the hooked end X2 can be positively engaged with the associated vertical door frame. In addition button lock 41 is inserted in a suitable aperture extending through sleeve and the member on which it slides to rigidly lock the device in place.

Centre panel 42 of member S is provided with a suitable notice indicating the fact of the vehicle being equipped with the device S.

Once the vehicle has been parked in a location for an overnight stay the cab doors 13 are locked and the device S, S′ are secured in place by the driver once he is ready to occupy the sleeper compartment Z behind the seats 20, 21. The appropriate bar B, B′ engages with the door frame resisting any attempt to open the door from outside. A curtain is provided to be drawn to isolate the sleeper compartment Z from the remamider of the cab interior. With the security arrangement shown anyone seeking unauthorised entry from outside the vehicle is faced initially with overcoming lock 16 and preferably quietly enough not to awaken the driven on compartment Z. Even if the widow is broken (an action which it cannot be readily undertaken without noise) the engagement of bar B, B′ with the door frame resists any attempt to open the door. Further the device S occupies a major part of the aperture 18 and so prevents physical entry by an intruder through the window.

The fact of use of the device S is clearly apparent from outside the vehicle even under low level lighting condtions and consequently a potential intruder may well decide that some alternative target should be selected.

When the occupant of the cab is ready to proceed the devices S, S′ are readily removed and stored.

### Industrial Applicability

Although the exemplary embodiment demonstrates the use of the invention on a commercial vehicle it is readily applied to other vehicles in which an occupant may choose to spend a period at a location where a vehicle is likely to be the subject of an attempt at entry.

The present invention serves to provide for improved vehicle security and for protection of the vehicle driver. The driver can consequently park with more confidence in a location otherwise unknown to him. Typically the invention provides protection when a driver is obliged to change his route from a previously selected one for whatever reason.

1. A method of providing security for an interior region of a vehicle having an opening bounded by a frame through which opening access can be had to the interior region from outside the vehicle, the frame being provided with a closure means such as a door, the closure means being displaceable relative to the frame between a closed position, when the opening is closed by way of the closure member and an open position wherein the closure member allows access through the opening to the interior region; the closure member containing a window characterised by the steps of:
1 locating from within the interior region over the window in the closure member a blocking device; the blocking device being adapted, in a working position, for demountable coupling of the blocking device to the closure member;
2 providing on the blocking device a displaceable extension such that, with the closure means in the closed position and the blocking means in its working position, the extension can be moved between:
a long position wherein the extension interacts with the frame or an extension thereof so as to resist movement of the closure member from the closed position towards the open position; and
a release position wherein the extension no longer interacts with the frame or an extension thereof so as to enable the closure member to move from the closed position towards the open position.

2. A method as claimed in claim 1 characterised in that the window contains at least one glass panel and the locating step includes positioning the blocking device between the interior region and the glass panel.

3. A method as claimed in claim 1 or claim 2 characterised in that the blocking device includes display means for information, such as a security warning, and the locating step serves to cause such a sign, such as a security warning, to be displayed outwardly through the window.

4. A method as claimed in any preceding characterised in that the step of providing locking means on the extension whereby the extension can be maintained in the locking position by a user located in the interior region.

5. A security unit for mounting on a door so as to extend across a window located in the door characterised in that the unit comprises a blocking device having at least two spaced apart fixing locations whereby the device can be mounted across a surround for the window defined by the door and at least one extension means mounted or the blocking device by means enabling the extension means in a first, retracted, position to lie within a boundary defined by a peripheral region of the door and in a second, extended, position to extend beyond the peripheral region of the door to interact with a region bounding the door so as to limit motion of the door away from a closed position; the extension means being capable of being secured, at least when in its extended position, relative to the remainder of the blocking device by a lock.

6. A unit as claimed in claim 5 characterised by the extension means being attached to the blocking device by a hinge allowing the extension means to pivot relative to the remainder of the blocking device.

7. A unit as claimed in claim 5 characterised by the extension means being attached to the blocking device by means allowing the extension means to slide relative to the remainder of the blocking device.

8. A unit as claimed in claim 5, 6 or 7 characterised by a lock for securing the extension means in its extended position relative to the remainder of the blocking device.

9. A road vehicle equipped with a device as claimed in claim 5, 6, 7 or 8.
